(19) United States
(12) Patent Application Publication
(10) Pub. No.: US 2025/0033239 A1
(43) Pub. Date: Jan. 30, 2025

(54) Process for the Extrusion of Wood Pellets, Co-Ratating Twin-Screw Extruder for the Extrusion of Wood Pellets, and Corresponding Wood Pellets

(71) Applicants: UNIVERSITE JEAN MONNET SAINT ETIENNE, SAINT ETIENNE (FR); UNIVERSITE CLAUDE BERNARD LYON 1, VILLEURBANNE (FR); CENTRE NATIONAL DE LA RECHERCHE SCIENTIFIQUE (CNRS), PARIS (FR); INSTITUT NATIONAL DES SCIENCES APPLIQUEES DE LYON, VILLEURBANNE (FR)

(72) Inventors: Frédéric BECQUART, SAINT PRIEST EN JAREZ (FR); Christian CARROT, SAINT ETIENNE (FR); Mohammed Abdelfetah GHRIGA, SAINT ETIENNE (FR)

(21) Appl. No.: 18/718,004

(22) PCT Filed: Dec. 8, 2022
(86) PCT No.: PCT/FR2022/052287

§ 371 Date: Jun. 7, 2024

(30) Foreign Application Priority Data
Dec. 9, 2021 (FR) FR2113217

(51) Int. Cl. B27L 11/00; B27M 1/02

(52) U.S. Cl. CPC B27L 11/005; B27M 1/02

(57) ABSTRACT

The invention relates to a method for extruding wood pellets, the method being characterized in that it comprises at least the steps of:
(a) providing pieces of wood;
(b) grinding and partially drying, in a twin-screw extruder including at least shear generating elements, pieces of wood to obtain wood particles having a reduced water content compared to the pieces of wood;
(c) compressing the particles and shaping in at least one die to obtain wood pellets.

The invention also relates to a wood pellet capable obtained with this method and a co-rotating twin-screw extruder intended for the extrusion of wood pellets

### FIELD OF THE INVENTION

The present invention relates to the field of extrusion of wood pellets, in particular with a twin-screw extruder.

### STATE OF THE ART

The field of production of wood pellets from co-products of the sawmills, in the form of sawdust or chips, is booming: 10% annual growth over the last 5 years and no significant cost variation over this period of the raw material which is classified as sawing waste from wood processing. The global geopolitical context in 2022 around the subject of energy however has generated inflation in the prices of this waste transformed into energy resource: the wood pellet for the energy.

Wood in the form of pellets is therefore recoverable as an energy source by being burned, thanks in particular to a boiler, source of combustion performance and lower environmental impact with minimized gaseous and particulate emissions, harmful to the environment. The heat produced by the combustion can either be used to produce heat for heating for example individual or collective housing, or produce another type of energy such as electricity or mechanical work.

The pellet manufacturing method available on the market consists of a circular press which forces through rollers, generally two rollers, wood in the form of sawdust already strongly dried beforehand (residual moisture content, generally less than 12% of the total mass), through multiple dies (holes) disposed radially in the circular metal casing of the press on which the rollers roll. The holes can be purely cylindrical or conical or mixed. These dies make it possible to obtain pellets with a diameter generally set at 6 mm, the usual standard falling within the standards qualifying a wood pellet for the energy.

The investment costs and the industrial infrastructures to produce the pellets by drying, conveying and storing on hold sawdust previously prepared for its final processing, are very high. The infrastructures of a production site are very substantial in size.

Associated with the high volumes treated in a production unit, the dimensions of the installations generate significant energy losses during the drying and conveying steps.

Storage volumes of up to several hundred of m³ require proportionate land requirements. The size of a complete production unit requires investments exceeding ten million Euros. Only the largest sawmills, producing sawdust and currently the only ones concerned with the processing of the latter, are capable of investment and therefore production. Small and medium-sized sawmills, unable to invest and amortize this type of installations due to their insufficient volumes to be treated, end up actually with stocks of sawdust currently unrecoverable on their sites and are forced to resell it to low-cost processors, well below the price after processing into marketable pellets.

The unique historical method for producing wood pellets for the energy does not offer flexibility for the final processing in the press and therefore offer few options for the improvement of the product. It also does not allow the recovery of wood derived from hardwoods with a few exceptions. Only the use of softwood species is currently possible. The hardwood species are very marginal and considered inadequate with the currently existing methods.

Through a processing of wood that has been previously heavily dried and which is therefore very hard, the mechanical breakages, particularly of the ball bearings of the rollers, are regular, generating random production interruptions and maintenance costs impacting the overall costs.

### Natural Anisotropy of Wood and Consequence in the Methods

Wood is in itself a heterogeneous, at all scales, molecular to macroscopic, and anisotropic, material. It is made up of three main components: cellulose, hemicellulose and lignin with effects of orientation of the cellulose fibers that constitute it and make it anisotropic. This anisotropy due to the fact that wood is fibrous generates shape factors and anisometry of the wood particles obtained during a sawing or grinding step. Whether in the form of fine or coarse sawdust or in the form of chips, wood appears with elongated, in the direction of the fibers, or flattened geometries. The co-products of the sawmills processed into pellets by the current presses all have shape factors making it possible to qualify this processed wood as anisometric. This is important because it has been demonstrated that the anisotropies and isometries related to the shape factor and to the structure of wood generate additional radial forces when these objects are forced to flow, therefore under pressure, in cylindrical geometric shapes such as dies capable of shaping wood (see document Effect of Fiber Orientation on Compression and Frictional Properties of Sawdust Particles in Fuel Pellet Production, DOI 10.1021/ef800923v 2009). The radial forces in the direction of flow ensuring the shaping, therefore generate more friction with three consequences: more energy required to produce at a fixed flow rate, degradation of the product through self-heating related to the friction (browning on the surface of the product) and, due to an unnecessary additional energy cost, a reduced maximum production capacity of the machine, which exerts the mechanical action.

The anisotropy of wood is therefore naturally present but, in addition, the current methods for producing wood pellets are subject to this anisotropy responsible for a shape factor of the incoming material which has never been able to date to be eliminated by an action after the final processing into pellets.

In the context of optimizing the energy costs and intensifying the methods, it becomes necessary to provide a method for more easily manufacturing wood pellets from an ideally isometric resource, starting from an anisotropic wood which is naturally in the form of anisometric particles, by using the water that it can naturally contain after sawing (i.e. without necessarily required addition of water or another liquid).

### DISCLOSURE OF THE INVENTION

According to a first aspect, a method for extruding wood pellets is proposed, the method being characterized in that it comprises at least the steps of:
(a) providing pieces of wood;
(b) grinding and partially drying, in a twin-screw extruder including at least shear generating elements, pieces of wood to obtain wood particles with a reduced water content compared to the pieces of wood, that is to say the pieces of wood from step (a) entering the extruder;
(c) compressing the particles and shaping in at least one die to obtain wood pellets.

According to one particular example, a method for extruding wood pellets is proposed, the method being characterized in that it comprises at least the steps of:
(a) providing pieces of wood;
(b) grinding and drying, in a twin-screw extruder including at least kneading elements and reverse screw pitch elements, pieces of wood to obtain wood particles with a reduced water content compared to pieces of wood, that is to say the pieces of wood from step (a) entering the extruder;
(c) compressing the particles and shaping in at least one die to obtain pellets.

Steps (a), (b) and (c) are preferably successive one after the other.

According to advantageous and non-limiting characteristics, taken alone or in combination, of this extrusion method:
Step (a) of providing pieces of wood comprises only providing pieces of wood as is without the addition of an additive such as a fluid.
The shear generating elements comprise kneading elements, and the grinding of step (b) is carried out by applying a shear force to the pieces of wood, thanks to the kneading elements of the extruder.
The shear generating elements comprise at least one reverse screw pitch element, and the pieces of wood are concomitantly moved along an axial direction, relative to the axis of the screws of the extruder, but retained by the reverse screw pitch element(s).
During step (b), the partial drying is carried out by using heat generated by the grinding to a temperature of at least 100° C.
Step (b) comprises at least one phase of discharging water extracted from the wood fibers, outside the extruder.
Compression step (c) is carried out by applying a radial compression force, relative to the axis of the screws of the extruder, so as to push the wood particles along a substantially radial direction, relative to the axis of the screws of the extruder, in the at least one die to form at least one extruded strand and obtain, after cutting, said wood pellets.
The method comprises a step (d) of final drying of the wood pellets at the outlet of the die, particularly to a moisture content of less than 12%, which makes it possible in particular to comply with the standards qualifying a wood pellet for the energy.
Step (d) is parameterized to obtain wood pellets with a moisture content comprised between 7% and 10%.
Steps (b), (c) and (d) are parameterized to obtain wood pellets with a moisture content of less than 12% and a density of at least 0.7.
Steps (b), (c) and (d) are parameterized to obtain wood pellets with a moisture content of less than 12% and a density of at least 0.8.
The pieces of wood provided in step (a) have natural moisture content greater than 40%, preferably of the order of 55%, and the wood particles obtained at the output of step (b) have a moisture content of less than 40%, preferably between 30% and 35%.
The wood particles obtained at the output of step (b) have an ovoid or even substantially spherical shape.
Steps (a) and (b) are repeated several times with the same pieces of wood and particles, before moving on to step (c).
In step (a), pieces of wood derived from softwoods, or pieces of wood derived from hardwoods, or pieces of wood derived from a mixture of softwoods and hardwoods, are provided.

According to a second aspect, a twin-screw extruder adapted to implement the wood pellet extrusion method according to the first aspect, is proposed.

A twin-screw, preferably a co-rotating twin-screw, extruder intended for the extrusion of wood pellets is particularly proposed, comprising:
two profiles of identical interpenetrating screws mounted in rotation (preferably in co-rotation) in a bore of a sheath, in which each screw profile comprises a shaft on which shear generating elements are mounted to grind and dry pieces of wood in order to obtain wood particles with a reduced water content compared to the pieces of wood, and
at least one lateral die (40) forming a lateral outlet relative to an axis of the screws of the extruder.

Preferred but non-limiting aspects of this twin-screw extruder, taken alone or in combination, are as follows:
Each screw profile comprises compression means mounted on the shaft, for a radial compression, relative to an axis of the extruder screws, of the wood particles in the direction of the at least one lateral die.
The compression means comprise direct pitch screw elements and kneading elements placed at the screw profile end, the direct pitch screw elements being arranged to push the wood particles onto the kneading elements.
The sheath is devoid of a wood outlet along a direction parallel to the axes of the screws of the extruder.
The shear generating elements comprise kneading elements (20).
The shear generating elements comprise at least one reverse screw pitch element (30).
The at least one reverse screw pitch element (30) is directly placed at the outlet of the kneading elements (20).
Each screw profile comprises at least one direct screw pitch element directly placed at the outlet of the kneading elements (20) and just before the at least one reverse screw pitch element (30).

According to a third aspect, a wood pellet capable of being obtained according to the wood pellet extrusion method according to the first aspect is proposed.

According to advantageous and non-limiting characteristics, the pellet has a moisture content of less than 12% after final drying and a density of at least 0.7 and preferably greater than 0.8.

Preferably, the wood pellet has a moisture content comprised between 7% and 10%.

Advantageously, the wood pellet cannot be disintegrated in water.

Preferably, the wood pellet is formed only of wood and particularly does not comprise any additives.

### DESCRIPTION OF THE FIGURES

Other characteristics, aims and advantages of the invention will emerge from the following description which is purely illustrative and not limiting and which should be read in relation to the appended drawings in which:

FIG. 1 represents one example of a screw profile portion of a twin-screw extruder for the implementation of the proposed wood pellet extrusion method.

FIG. 2 represents one example of a kneading element of a twin-screw extruder for the implementation of the proposed wood pellet extrusion method.

FIG. 3 schematically represents the steps of one embodiment of the proposed wood pellet extrusion method.

FIG. 4 represents one example of the arrangement of lateral dies at the outlet of a twin-screw extruder for the implementation of the proposed wood pellet extrusion method.

### DETAILED DESCRIPTION OF THE INVENTION

The invention proposes a method for extruding wood pellets. Typically, this method can be implemented with a co-rotating twin-screw extruder.

It should be noted here that all the percentages expressed in the remainder of the description are, unless otherwise stated, mass percentages.

### Twin-Screw Extruder

According to a first aspect, a twin-screw, preferably a co-rotating twin-screw, extruder adapted to implement the proposed wood pellet extrusion method, is proposed. It is a continuous method. It is noted that it is possible in practice to use a succession of twin-screw extruders, so that the present method will not be limited to a single twin-screw extruder.

In a known manner, a co-rotating twin-screw extruder is a transformation machine made up of two profiles of identical interpenetrating screws rotating in the same direction in the bore of a sheath. The screws are driven by a motor unit and both rotate at the same speed. One or several supply areas can be set up. In general, a supply area is chosen at the start of the screw profile if necessary with lateral or secondary meters. At the outlet, at least one die ensures the conformation of the material in the form of a strand whose section can take any shape. The die can be cylindrical or conical or combining cylindrical and conical sections in the case of a round section. Any other section being possible according to the same principle.

The particularities and advantages of an extruder of this type, usually used to transform a viscous material into an ability to flow, are due:
To the modularity of the screw profiles through the multitude of assembled elements. By “screw profile” it is meant all the assembled elements, direct pitch screw elements, reverse pitch screw elements and kneading elements, on each shaft of the twin-screw extruder, as explained below.
To the modularity of the sheath (detailed later).
To the diversity of possible dies through their geometric design and particularly their section, to conform the material leaving continuously in its final shape at the outlet of the extruder.
To the modularity of the associated peripheral equipment for the supply of the extruder or the extraction.

A screw profile of an extruder can be assembled under tolling by the association of three main types of usual elements for this method which can have their own roles or be associated in synergy. They all have the same external diameter but can be of variable length and are assembled on screw shafts which can be splined or of sections preventing their free rotation on the shafts, for example a hexagonal section, or another system preventing the rotation such as a key system. In all the cases of a conventional extrusion with an axial exit of the material at the end of the extruder, all of the elements chosen, whatever their type, whatever their number and length, must have an assembled length equal to the length of the screw shafts supporting them when operating in a classic configuration. The assembly without clearance between the elements is usually held by tightening screws at the end of the shaft. These screw profiles may end with a pointed outer shape. The chosen order of assembly of the screw elements will allow generating areas with specific functionalities to carry out specific tasks in each developed specific area.

The sheath which surrounds the screw profiles generally ensures the sealing and is pressure-resistant if it is completely closed but also allows thermal exchanges by being heated or on the contrary cooled with a regulated cooling system integrated by circulation of a liquid or gaseous fluid. The heating or cooling is not constant across the entire profile.

It can be adjusted in differentiated areas all along the sheath where each segment/sheath element will have its own heating and cooling system.

The material exiting the extruder and its sheath/screw system will be shaped by means of a die. In general, the die is fixed to the last sheath element with an intermediate convergent, all in the axis of the screw profile. This die can include a single outlet or combine several of them.

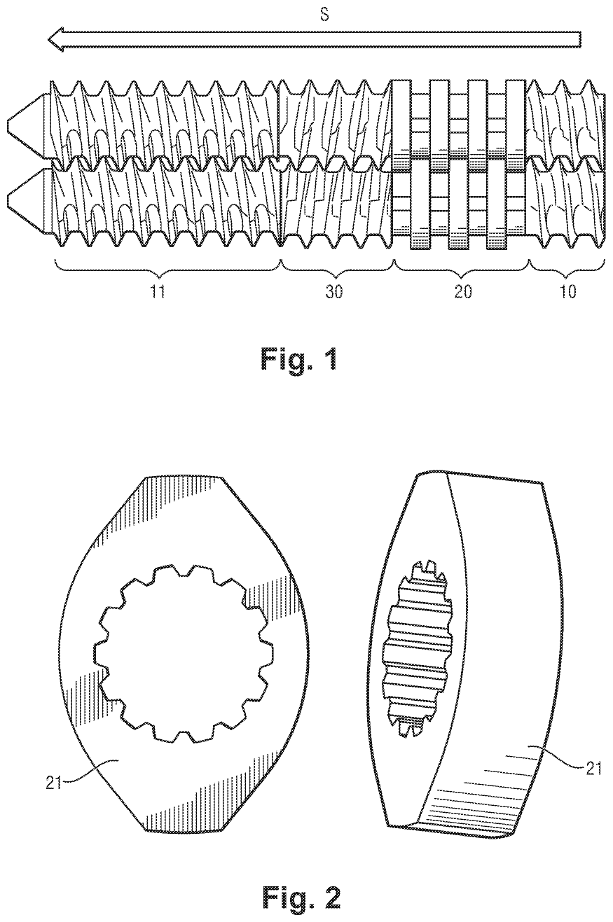

With reference to FIG. 1, where the arrow S represents the direction of flow of the material, the elements commonly used to constitute a screw profile are:
The direct pitch screw elements (10; 11) allow conveying the material in the direction of flow. These screw elements are characterized by their pitch (distance traveled per revolution) and the number of channels separated by threads, from 1 to 3 channels, generally 2. Moreover, their geometry, called conjugate geometry, ensures a self-cleaning effect during the rotation and during the conveying of the material, the material circulates in continuous ducts in the shape of a deformed 8 and passing from one screw to the other through the interpenetration area between screws. The material is also subjected to a shear. Intense shear is also generated in the clearance between the threads of the screws and the sheath. With the direct pitch elements alone, the extruder is not completely filled with the material and the material is therefore not pressurized before having reached the last elements before the die. The screws exert only a pressure effect when arriving at the outlet to pass through the reduced section die. The extruder is then locally filled with pressurized material.
The reverse pitch elements 30 generate a stream opposite to the direction of flow and make it possible to locally generate filling, pressurization and a mixing action. They can also allow locally increasing the shear, as well as the self-heating and the dewatering as explained below.
The kneading elements 20, called Wide Kneading Elements (KNE) or Thin Kneading Elements (TKE), are used to generate under shear a dispersive mixing or a distributive mixing of viscous systems. FIG. 2 illustrates an example of geometry of Kneaders 21, having a bilobed profile with splined central axis. Their section is identical to or does not exceed that of the screws characterized by their diameter, but they are offset from each other in the axis of the screw and assembled in blocks (FIG. 1, 7 mixers assembled for example, alternately, with positive or negative angle offsets. The shearing and the mixing generated between two consecutive elements will depend on this offset. Like for the other elements, these kneaders are interpenetrated and can allow the material to pass from one screw to the other, and are combined for a self-cleaning effect. By the offset angle, axial transfers of the fluid, ensuring the mixing, are also possible. Generally, the offset angle between each kneader, taken two by two, remains constant in the block but it can also vary by the modularity offered. Some manufacturers propose kneader blocks directly built in one piece and not by the assembly of kneaders individually.

Thus, by the modular assembly of the different types of screw elements on the shafts to constitute a profile, there is an extremely high number of combinations of elements and therefore of possible profiles.

On the other hand, the geometric profiles of each screw are chosen to allow the implementation of the proposed wood pellet extrusion method. They are made up of the same sequences of elements so that they can interpenetrate each other, be combined and rotate without mechanical interference.

The sheath is generally made up of a set of sheath elements (segments). These sheath elements being interchangeable in their positioning one after the other, as for the screw elements, their assembly can therefore be done under tolling. Being able to be heated or cooled individually, each segment can have its own setpoint temperature. The sheath as a whole may have possible openings all along the sheath to:
either supply the extruded system with a liquid, a solid or a viscous system by means of an adequate supply system such as a volume or weight flow rate meter, a pump or even another extruder,
or discharge liquid (such as water) or vapors. Preferably, the discharge means comprise one or several openings in the sheath making it possible to discharge water vapor resulting from the wood drying during the proposed extrusion method. Other additional openings can be complementary to discharge liquid extractions, by simple gravity, based on water as part of the proposed method.

As explained in detail later, the proposed twin-screw extruder has the particularity of having:
two profiles of identical interpenetrating screws mounted in rotation (preferably in co-rotation) in a bore of a sheath, in which each screw profile comprises a shaft on which shear generating elements are mounted to grind and dry pieces of wood in order to obtain wood particles having a reduced water content compared to the pieces of wood, and
at least one lateral die 40 forming a lateral outlet relative to an axis of the screws of the extruder.

### Extrusion Method

According to another aspect, a method for extruding wood pellets is proposed.

In a known manner, wood in its natural state is an anisotropic fibrous material which remains so after processing in the usual and current methods for processing wood as a structural material (beam, board, etc.). As a co-product of wood sawing, it takes the form of sawdust or chips. Due to the anisotropy of wood, it is a material where the fibers are oriented, which leads to sawing co-products with elongated, flattened shapes and in all cases with anisometric geometries which differ greatly from the ideal spherical shape to hope for isometry. These shapes are as much due to the natural structure of wood as it is made, as to the usual tools that sawed or grinded it.

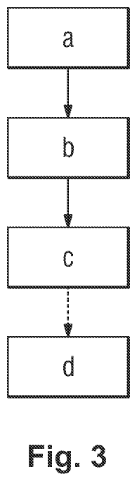

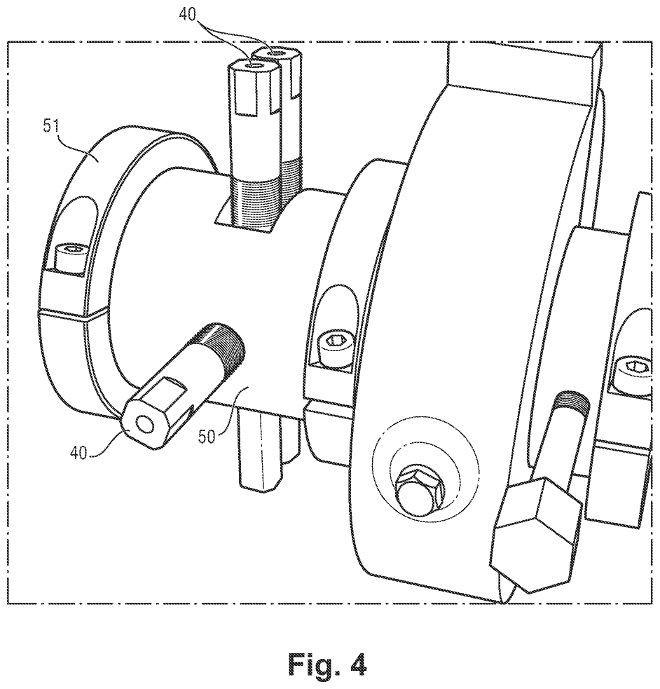

With reference to FIG. 3, the method comprises in particular the following steps:
(a) providing pieces of wood, co-product of sawing or grinding preferably “as is”, that is to say having not undergone any particular treatment, and particularly with their natural water content, at the natural balance with the ambient environment, between 30% and 80%, advantageously between 40% and 70%, very advantageously between 40% and 60%, preferably of the order of 55%, and before any processing in the extruder. These pieces of wood have any shape other than the sphere: elongated and/or flattened shapes like chips, and have anisotropic fibers. It should be noted that wood could in some cases have undergone prior drying or, on the contrary, have been re-moistened, to the extent that it is simply a question of restoring a natural water content of wood before sawing (for example if it is wished to use wood that has already dried over time, for example during a storage, and which is no longer in its state as it is just after sawing of a tree), and it will be understood that this possible modification of the moisture content will be done without or with mechanical treatment of wood such as kneading. Wood remoistening can also be done in the extruder itself by means of a supply pump as a device connected to the sheath of the extruder or to one of its segments constituting it. The use of natural wood as is will nevertheless remain preferred, as it allows for minimal costs and handling. In order to remove any mineral or metal residue that may be present as a contaminant in wood to be processed and that cannot pass through the extruder, wood could have been rinsed with water or separated from its pollutants by simple flotation in water, ideally continuously and in this case integrated into the overall method, before extrusion.
(b) grinding and drying, in a twin-screw extruder, pieces of wood to obtain it in the form of particles with a reduced water content and with an overall particle size lower than that of wood entering the machine. Additionally, this wood can have ovoid and preferably substantially spherical shapes after grinding that it did not have at the extruder inlet. It should be noted that the drying of this step is not a drying that removes all of the water present in the pieces of wood, we can therefore speak of partial drying;
(c) compressing and densifying wood and shaping in one or several dies to obtain one or several strands, continuously, that could then be cut into final pellets with sufficient mechanical strength in order not to unbind and to meet after final drying, post-extrusion, the specifications of the wood pellets for the energy based on the EN+ standard or other equivalent standards in force.

### Step (a)

Step (a) of providing pieces of wood essentially consists in introducing pieces of wood into a twin-screw extruder.

It is specified that preferably, wood is introduced continuously “as is”, without the addition of a fluid or of any additive. In the present case, by “addition of fluid” it is understood the addition of water, of an aqueous solution or any liquid that can have a lubricating function in the extrusion method, and/or of final binder of the extruded strand(s).

Indeed, the introduction of the pieces of wet wood without the addition of a fluid is a particularly advantageous arrangement of the invention, which (as will be developed below) makes it possible to quickly manufacture wood pellets by using, for a single input, wood shavings, chips or sawdust obtained as co-products of processed trees or wood to be recycled post-usage, at the end of its life.

One of the advantageous characteristics of the proposed extrusion method is that it is effective with any type of wood. Particularly, it could be applied to pieces of wood derived from both softwood and hardwood.

Thus, in step (a), it is for example possible to provide pieces of wood derived from softwood, or pieces of wood derived from hardwood, or pieces of wood derived from a mixture of softwood and hardwood.

### Step (b)

As indicated previously, step (b) comprises the grinding, in the twin-screw extruder, of pieces of wood whether in the form of sawdust resulting from raw grinding, of wood chips, of wood shavings, or of any other form of wood having been previously grinded or not, to obtain a wood powder having a reduced particle size compared to the entering wood, completed by a shape factor approximating the sphere. The wood resource can come from either wood from recently felled trees or used wood to be recycled.

More specifically, step (b) is carried out by generating shear on the extruded material. In other words, the two interpenetrating screws of the co-rotating twin-screw extruder move the pieces of wood along a longitudinal direction thanks to direct pitch screw elements, while exerting shear locally in one or several targeted areas in the screw profile, by using specific elements of the screw profile.

As such, the twin-screw extruder can comprise in its screw profile at least one series of kneading elements 20 forming a block of this type of elements (forming a “kneading” area). The kneading elements 20 can be directly assembled at the inlet of the twin-screw extruder, or more ideally preceded by an ideally short section of direct pitch screw elements 10 to generate an axial pushing force in the block composed of several kneaders 21 and thus effectively feed the kneading area without jamming.

In a preferred but not obligatory manner, reverse screw pitch elements 30 can also be provided, which are for example directly placed at the outlet of the kneading elements 20 constituting a block to retain the wood or separated by one or several direct pitch elements. There are also direct screw pitch elements 11 at the outlet of the reverse screw pitch elements 30 to convey particles that will be obtained.

The kneading elements of the extruder make it possible to exert significant shear, particularly as a complement to the reverse screw pitch elements that hold the wood in the kneader and increase the filling and therefore the shear. Typically, the kneaders allow grinding by breaking agglomerates or original particles into smaller particles. For this, they are assembled together consecutively with angle offsets chosen because they are adjustable. An angle offset of around 90° is preferred here. By “screw profile”, it is meant all the assembled elements, direct pitch screw elements, reverse pitch screw elements and kneading elements, on each shaft of the twin-screw extruder.

Moreover, the kneading elements allow densification at the outlet by compression (strong pressure on the external thread of the kneader). As the wood can no longer pass through the axis at the end of the extruder, it is the pressure effect at the top of the threads of these kneaders that dominates.

FIG. 1 illustrates an example of a screw profile portion of a twin-screw extruder for the implementation of the desired shear in the proposed wood pellet extrusion method.

Step (b) is also a step of drying, in the extruder, processed wood to reduce its water content. As stated above, there is particularly partial drying of wood since present water is not entirely removed.

The twin-screw extruder, and particularly the combination of the kneading elements and the reverse screw pitch elements, indeed makes it possible to simultaneously heat wood while it is grinded.

According to one particularly advantageous technical arrangement, the drying can indeed be carried out by using heat generated by work on the material during grinding.

In other words, the energy dissipated during the grinding of the processed material, by the mechanical work exerted on the sheared material, generates self-heating which allows drying the wood, advantageously at a temperature of at least 100° C. approximately, it should be noted that the reverse screw pitch elements can contribute to the drying by dewatering wood to a certain extent (discharge of water in the liquid state), and in addition, thanks to the counter threads, it is possible to generate more self-heating and therefore a more efficient transition of water to vapor state.

By “drying” it is understood that part of the water naturally present in the wood is evaporated and discharged due to the temperature of at least 100° C. We also speak of partial drying since present water is not entirely discharged from the extruder. Very advantageously, this drying step, inside the extruder, by using the mechanical work, source of heat, caused by the grinding, allows time and energy saving compared to the known methods. The self-heating is indeed “free” and in practice proves very effective. Known methods on the contrary sought to dissipate heat produced by the self-heating (the energy was not only lost, but its dissipation had a cost) to prevent the wood from starting to carbonize since it was already dry (below 12% moisture content). In the present method, this risk does not exist since the moisture content is natural, and the concomitant grinding/drying in practice only improves the properties of the particles, as explained below.

It should be noted that this step does not exclude possible additional heating by external energy input (for example heater bands), in particular above 120° C., more preferably in the interval 130° C.-160° C.

By way of example, a proportion comprised between 10% and 80%, preferably between 20% and 60%, preferably between 30% and 40%, of the water naturally present in the wood, entering the extruder, can be extracted during step (b). Preferably, the residual moisture content drops below 40%, preferably between 25% and 40%, preferably between 30% and 35%, particularly around 32%. This corresponds, starting from a moisture content of 55%, to an extraction of approximately 35% of the water naturally present in wood.

In addition, step (b) can comprise a phase of discharging water extracted from wood, outside the extruder. Typically, this phase can be carried out by using an opening or several specific openings of the sheath to discharge water in liquid and/or gaseous form.

### Repetition of the Steps (a) and (b)

Depending on the desired grinding fineness, it is possible to repeat steps (a) and (b) several times before moving on to step (d). To do so, the particles can be extracted from the extruder after step (b), then directly reintroduced into the extruder (or another extruder) to start the method again in step (a).

### Step (c)

Step (c) is a step of compressing the particles and shaping them in one or several dies to obtain one or several wood strands which, cut after exiting the extruder, will give pellets.

More specifically, step (c) can be carried out by applying a radial compressive force, relative to the axis of the screws of the extruder, on the wood, the wood being simultaneously pushed along a radial direction, relative to the axis of the screws of the extruder, in one or several dies to form pellets. The die(s) are thus positioned laterally relative to the axis of the screws and to the sheath, that is to say they are not positioned at the end forming the outlet of the extruder and along the axis of the extruder as is generally the case, but on the side. We speak of lateral dies. Thus, the outlet orifice formed by each die is positioned laterally relative to the axis of the screws of the extruder, forming a lateral outlet, so as to allow lateral extrusion relative to the axis of the screws of the extruder. We can also speak of a radial die even for the case where the axis of the die is not exactly radial relative to the axis of the extruder. There is indeed always an extension of the die along a generally radial direction relative to the extruder. In any case, as indicated above, there is no die positioned axially at the end forming the outlet of the extruder.

To apply a radial compressive force relative to the axis of the screws of the extruder, it is possible to use for example conventional direct pitch screw elements that will push the particles onto one or several kneaders, without angle offset or with an angle offset, placed at the end of the profile without the possibility for the solid material to exit in the axial direction. Instead of the last sheath element being opened to extrude in the axial direction of the screws, conventionally, it is modified or completed with a device that does not allow wood to exit in the axial direction. One or several lateral dies are particularly provided as explained above. Each die can for example have an elongated shape extending laterally relative to the sheath of the extruder, and having a spinning orifice, preferably with a diameter comprised between 5 mm and 15 mm, for example of the order of 6 mm, 8 mm, 10 mm, or 12 mm.

FIG. 4 illustrates one example of arrangement of several lateral dies 40 relative to the sheath 50 of a twin-screw extruder as proposed. It is noted that the axial end 51 of the sheath does not have an outlet/orifice for the passage of wood. In the example illustrated here, the assembly flange 51 is therefore solid, without outlet orifice allowing the material to exit. If one or several axial orifices exist, revealing for example the screw ends and their terminal nut tightening the screw profile, a wood sealing is ensured in the axial direction between these screw ends and the radial compression area where the radial extrusion dies are placed.

It should also be noted that step (c) does not exclude exits of material along an axial direction of the extruder, particularly of gaseous fractions such as water vapor and/or of liquid fractions such as water or water lightly loaded with submicron wood particles giving a slightly viscous appearance. Wood can therefore possibly pass into the clearances between mechanical parts by being reduced to the submicron particulate state and to the pasty state because mixed with the liquid fraction. A sealing device can also prevent any liquid and/or gas passage in the axial direction as presented with the assembly flange 51.

### Step (d)

According to one particularly advantageous arrangement, the method can comprise a step (d) of drying the pellets at the outlet of the die(s) used to exit densified and shaped wood from the extruder. Preferably, the strands are cut into pellets before the drying, although the opposite remains possible.

As indicated previously, by “drying” is meant an operation consisting in heating the pellets to evaporate part of the water they contain. It can also be caused partially or entirely by the convection taking place during the natural cooling of the extruded strand because it is previously heated by the mechanical work of the material during the passage through the die.

As indicated previously, step (b) allows previously drying the particles which are then formed into pellets.

However, the wood particles, and therefore the pellets directly at the outlet of the die, still have moisture content of the order of 32%, while it is desired to go below 12% as explained.

Thus, step (d) makes it possible to further reduce the moisture content of the pellets, advantageously below 12%, preferably between 7% and 10%, very preferably to approximately 8%. In other words, step (d) is a finishing drying step, which is optional insofar as the pellets have already been dried previously. Furthermore, this step is necessarily shorter and especially less energy-intensive than the usual drying steps of the prior art, because the pellets are already partially dried thanks to the mechanical work during step (b).

### Wood Pellets

According to a third aspect, wood pellets are proposed, the pellets being obtained according to the wood pellet extrusion method described previously.

It is seen that not only is the method for obtaining them more energy efficient, simpler and less expensive, but in addition these pellets have better physical properties than those obtained by the known methods: these pellets have densities of 1.1 to 1.2 when they are humid (at the output of step (c), i.e. with a moisture content of the order of 32%) and at least 0.7 or around 0.8 once dried (at the output of step (d), i.e. with a moisture content of less than 12%) to be compared with the densities of 0.6 to 0.7 generally observed for the pellets obtained by the known methods.

Ultimately, the wood pellets obtained according to the proposed extrusion method have a moisture content of less than 12%, preferably a moisture content of less than 10%, and more preferably a moisture content comprised between 7% and 10%, for example of the order of 8%. Such wood pellets also have a density of at least 0.7, preferably at least 0.8.

Furthermore, the wood pellets obtained according to the proposed extrusion method have the particularity and the advantage of not disintegrating in water. Therefore we speak of wood pellets that cannot be disintegrated in water. Disintegration is defined by a return of the wood to the state of particulate powder close to its state before processing, by natural disaggregation when a pellet is placed in water at room temperature around 20° C. This is observed in a few tens of seconds or minutes at most with the pellets conventionally produced by the roller presses of the prior art described in the introduction. The pellet produced by the proposed extrusion method does not disintegrate after 6 hours and even after several days of soaking.

It is recalled that the wood pellets obtained according to the proposed extrusion method are advantageously wood pellets without additives. We can speak of wood pellets formed solely from wood, that is to say only consisting of wood.

The invention claimed is:

1. A method for extruding wood pellets, wherein the method comprises at least the steps of:
(a) providing pieces of wood;
(b) grinding and partially drying, in a twin-screw extruder including at least shear generating elements, pieces of wood to obtain wood particles having a reduced water content compared to the pieces of wood;
(c) compressing the particles and shaping in at least one die to obtain wood pellets.

2. The method of claim 1, wherein step (a) of providing pieces of wood comprises only providing pieces of wood as is without the addition of an additive such as a fluid.

3. The method of claim 1, wherein the shear generating elements comprise kneading elements, the grinding of step (b) being carried out by applying a shear force to the pieces of wood, thanks to the kneading elements of the extruder.

4. The method of claim 3, wherein the shear generating elements comprise at least one reverse screw pitch element, and wherein during the grinding of step (b), the pieces of wood are concomitantly moved along an axial direction, relative to the axis of the screws of the extruder, but retained by the at least one reverse screw pitch element.

5. The method of claim 1, wherein during step (b), the partial drying is carried out by using heat generated by the grinding to a temperature of at least 100° C.

6. The method of claim 1, wherein step (b) comprises at least one phase of discharging water extracted from the wood fibers, outside the extruder.

7. The method of claim 1, wherein the compression step (c) is carried out by applying a radial compression force, relative to the axis of the screws of the extruder, so as to push the wood particles along a substantially radial direction, relative to the axis of the screws of the extruder, in the at least one die to form at least one extruded strand and obtain, after cutting, said wood pellets.

8. The method of claim 1, comprising a step (d) of final drying of the wood pellets at the outlet of the die, particularly to a moisture content of less than 12%.

9. The method of claim 8, wherein step (d) is parameterized to obtain wood pellets with moisture content comprised between 7% and 10%.

10. The method of claim 8, wherein steps (b), (c) and (d) are parameterized to obtain wood pellets with a moisture content of less than 12% and a density of at least 0.7.

11. The method of claim 8, wherein steps (b), (c) and (d) are parameterized to obtain wood pellets with a moisture content of less than 12% and a density of at least 0.8.

12. The method of claim 1, wherein the pieces of wood provided in step (a) have a moisture content greater than 40%, and the wood particles obtained at the output of step (b) have a moisture content of less than 40%.

13. The method of claim 1, wherein the wood particles obtained at the output of step (b) have an ovoid or even substantially spherical shape.

14. The method of claim 1, wherein steps (a) and (b) are repeated several times with the same pieces of wood and particles, before moving on to step (c).

15. The method of claim 1, wherein in step (a), pieces of wood derived from softwoods, or pieces of wood derived from hardwoods, or pieces of wood derived from a mixture of softwoods and hardwoods, are provided.

16. A co-rotating twin-screw extruder intended for the extrusion of wood pellets comprising:
two profiles of identical interpenetrating screws mounted in co-rotation in a bore of a sheath, in which each screw profile comprises a shaft on which shear generating elements are mounted to grind and dry pieces of wood in order to obtain wood particles with a reduced water content compared to the pieces of wood, and
at least one lateral die forming a lateral outlet relative to an axis of the screws of the extruder.

17. The twin-screw extruder of claim 16, wherein each screw profile comprises compression means mounted on the shaft, for a radial compression, relative to an axis of the extruder screws, of the wood particles in the direction of the at least one lateral die.

18. The twin-screw extruder of claim 16, wherein the compression means comprise direct pitch screw elements and kneading elements placed at the screw profile end, the direct pitch screw elements being arranged to push the wood particles onto the kneading elements.

19. The twin-screw extruder of claim 16, wherein the sheath is devoid of a wood outlet along a direction parallel to the axes of the screws of the extruder.

20. Twin-screw extruder of claim 16, wherein the shear generating elements comprise kneading elements.

21. The twin-screw extruder of claim 16, wherein the shear generating elements comprise at least one reverse screw pitch element.

22. The twin-screw extruder of claim 21, wherein the at least one reverse screw pitch element is directly placed at the outlet of the kneading elements.

23. The twin-screw extruder of claim 21, wherein each screw profile comprises at least one direct screw pitch element directly placed at the outlet of the kneading elements and just before the at least one reverse screw pitch element.

24. A wood pellet capable of being obtained according to the wood pellet extrusion method of claim 1, having a moisture content of less than 12% and a density of at least 0.7, wherein the wood pellets cannot be disintegrated in water.

25. The wood pellet of claim 24, being formed only of wood and not comprising any additive.

26. The wood pellet of claim 24, having a moisture content comprised between 7% and 10%.

27. The method of claim 1, wherein the pieces of wood provided in step (a) have a moisture content of the order of 55%, and the wood particles obtained at the output of step (b) have a moisture content between 30% and 35%.
